(19) United States
(12) Patent Application Publication
(10) Pub. No.: US 2016/0125020 A1
(43) Pub. Date: May 5, 2016

(54) SYSTEMS AND METHODS FOR MANAGING CONTACT INFORMATION

(71) Applicant: VONAGE NETWORK LLC, Holmdel, NJ (US)

(72) Inventors: Natan Shaltiel, Tel Aviv (IL); Sagi Dudai, Tel Aviv (IL)

(21) Appl. No.: 14/526,931

(22) Filed: Oct. 29, 2014

(51) Int. Cl. G06F 17/30; H04L 12/26; H04L 29/06

(52) U.S. Cl. CPC G06F 17/30377; G06F 17/3053; H04L 65/1006; H04L 43/067

(57) ABSTRACT

Systems and methods for managing and presenting contact information to users of display terminals are presented herein. In some embodiments, the method includes receiving a request to display contact information associated with a contact stored in an address book associated with a first user, wherein the stored contact information includes a plurality of address entries, and displaying at least some of the plurality of address entries for the contact, wherein at least one displayed address entry is visually distinguishable from at least one other displayed entry for the contact based on a recentness score associated with each of the plurality of address entries.

### BACKGROUND OF THE INVENTION

1. Field of the invention

Embodiments consistent with the present invention generally relate to methods and apparatus for managing and presenting contact information to the user of a display terminal.

2. Description of the Related Art

Over the course of months or years, the user of a display-equipped communications terminal such, for example, as a smartphone, softphone client, or desktop phone (each, a “display terminal”) may accumulate a substantial number of stored address entries for the same business and/or personal contact. At some point, one or more of these address entries may become obsolete and, therefore, invalid as a means for establishing a communication session with the contact. For example, a person leaving a position with one employer to work for another or undertaking an intra-company transfer to a different location for the same employer will no longer be reachable by one or more of the phone number(s), e-mail address, account identifier, username and/or any other address entries associated with their previous position(s) and/or work location(s).

Accordingly, there is a need for improved methods and systems for managing and presenting contact information to the user of a display terminal.

### SUMMARY OF THE INVENTION

The inventors herein propose systems and methods for organizing and presenting stored contact address entries, to the user of a display terminal, in a manner which enables the user to determine at a glance which of the entries, if any, are still likely to be a valid address for establishing a communication session with the contact associated with the address entries.

In some embodiments, the method includes receiving a request to display contact information associated with a contact stored in an address book associated with a first user, wherein the stored contact information includes a plurality of address entries, and displaying at least some of the plurality of address entries for the contact, wherein at least one displayed address entry is visually distinguishable from at least one other displayed entry for the contact based on a recentness score associated with each of the plurality of address entries.

In some embodiments, the method includes calculating a recentness score for each address entry of a plurality of entries associated with a contact stored in an address book associated with a first user based on at least one of stored prior communication session data and date of address entry creation, and storing the calculated recentness score in association with a corresponding address entry.

In some embodiments, a system for presenting contact information in an address book on a display terminal may include an address book associated with a first user, wherein the address book includes at least one contact including a plurality of address entries, prior communication session data database storing prior communication session data associated with each address entry of the plurality of address entries for the at least one contact, a recentness scoring generator configured to calculate a recentness score for each address entry of the plurality of address entries for the at least one contact, and a display terminal configured to display at least some of the plurality of address entries for the contact, wherein at least one displayed address entry is visually distinguishable from at least one other displayed entry for the contact based on the recentness score associated with each of the plurality of address entries.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A depicts a block diagram of a system for managing and presenting address entries from an address book accessible using a display terminal, according to one or more embodiments of the invention;

FIG. 1B depicts a block diagram of a system for managing and presenting address entries from an address book accessible using a display terminal, according to one or more other embodiments of the invention;

FIG. 2 is a flow diagram of a method for accumulating data useful in assessing the “recentness” of address entries stored as part of contact information in an address book, according to one or more embodiments of the invention;

FIG. 3 is a flow diagram of a method for initiating display of address entries according to an assessment of recentness formed according to one or more embodiments of the invention;

FIG. 4 is a flow diagram of a method for computing a recentness score as, for example, a sub-process of the method of FIG. 3, according to one or more embodiments of the invention;

FIG. 5A is a tabular representation of illustrative prior communication session data and address entry creation data used to derive recentness scores for a plurality of address entries associated with a contact, according to one or more embodiments of the invention;

FIG. 5B is a graphical depiction of changes in the recentness of respective address entities with respect to time, as measured according to one or more embodiments of the invention;

FIG. 6A depicts a display terminal operated by a user to visually present a list of contacts in an address book, from which the user may specify a contact with whom he or she wishes to initiate a communication session according to one or more embodiments of the invention;

FIG. 6B depicts the display terminal of FIG. 6A operated by a user to display a list of address entries for a selected contact, the address entries being visually distinguishable from one another on the basis of recentness according to one or more embodiments of the invention; and

FIG. 7 is a detailed block diagram of a computer system, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention include a system and method for managing and presenting contact information for various entities. Some exemplary embodiments consistent with the claimed invention improve upon standard address book functionality by providing the user with a way to readily ascertain the currency (i.e., “recentness”) of each address entry associated with a particular contact before deciding upon which address entry to use for purposes of establishing a communication session with that contact. The ability to distinguish recently used and/or added address entries from older ones that are less likely to be active (i.e., have gone stale) enhances the experience of those users who choose not to delete a particular address entry in order, for example, to preserve identifying information associated with prior text message exchanges (i.e., Short Message service (SMS) or Multimedia Message Service (MMS) message exchanges) with a contact who had made extensive use of a now obsolete/stale mobile telephone number or contact identifier.

Various embodiments of systems and methods for managing and presenting contact information for various entities are provided below. In the following detailed description, numerous specific details are set forth to provide a thorough understanding of the claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

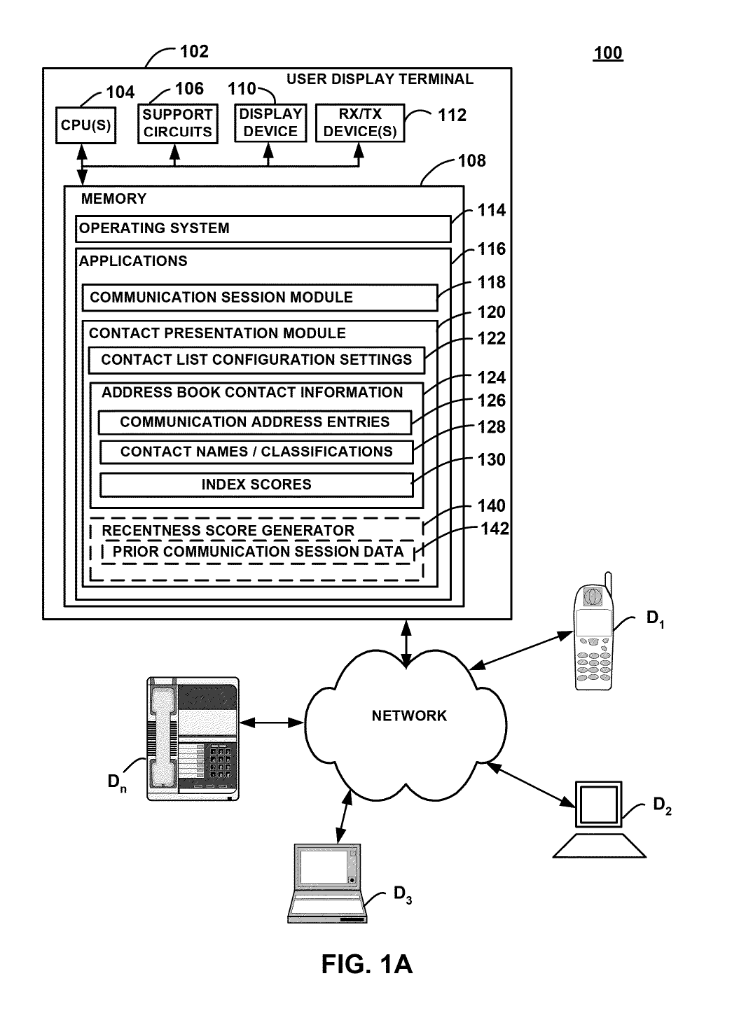

FIG. 1A depicts a block diagram of an end user device 102 (“display terminal”) for managing and presenting address entries from an address book, according to one or more embodiments of the invention. The display terminal 102 comprises Central Processing Unit (CPU) 104, support circuits 106, a memory 108, a display device 110, and transmission and receiving devices 112. In some embodiments display terminal 102 is a mobile terminal and the transmission and receiving devices 112 comprise one or more wireless transceivers compliant with corresponding wireless transmission protocol(s) such as IEEE 802.11, IEEE 802.13, Bluetooth, and/or cellular transmission protocols such as CDMA, TDMA, and/or GSM.

The CPU 104 may comprise one or more commercially available microprocessors or microcontrollers that facilitate data processing and storage. The various support circuits 106 facilitate the operation of the CPU 104 and include one or more clock circuits, power supplies, cache, input/output circuits, and the like. The memory 108 comprises at least one of Read Only Memory (ROM), Random Access Memory (RAM), disk drive storage, optical storage, removable storage and/or the like. In some embodiments, the display device 110 may be a touch screen able to accept input from a user's finger or input from a stylus. In some embodiments, the memory 108 comprises an operating system 114 and one or more applications 116. In some embodiments, applications 116 include a communication session module 118 configured, by execution of instructions by CPU 104, to set up a telephone call or send an SMS or MMS message to an intended recipient via network 127.

The network 127 comprises one or more communication systems that connect computers by wire, cable, fiber optic and/or wireless link facilitated by various types of well-known network elements, such as hubs, switches, routers, and the like. The network 127 may include one or more of an Internet Protocol (IP) network, a public switched telephone network (PSTN) 130, and/or other mobile communication networks, and may employ various well-known protocols to communicate information amongst the network resources.

In some embodiments, applications 116 further include a contact presentation module 120 comprising contact list configuration settings 122, one or more address books containing contact information 124, and one or more communication address entries 126. In some embodiments, each address entry may include, for example, a telephone number, an e-mail address, an account identifier, and/or some other contact identifier or network address such as a SIP (Session Initiation Protocol) address. The details and functionality of SIP can be found in the Internet Engineering Task Force (IETF) Request for Comments (RFC) Paper No. 3261 entitled, “SIP: Session Initiation Protocol,” that is herein incorporated in its entirety by reference. In some embodiments, the address book contact information 124 further includes contact names and classifications 128 including the first and last name of each contact, an entity classification (e.g., business or personal), as well as an recentness score 130 for each address entry.

As explained in greater detail below, the role of the recentness score 130 is to provide an objective basis for distinguishing between those address entries which have been recently used and/or created (so as to justify a higher confidence that a call invite, SMS message or e-mail sent by the user's display terminal to that address will be received by the intended recipient) and those address entries having a lower likelihood of reaching an intended recipient. In some embodiments, the recentness score is calculated or otherwise determined by a recentness score generator 140 from prior communication session data 142 stored in memory. In some embodiments, the communication session data 142 are stored locally in memory 108 or in a separate database communicatively coupled to the recentness score generator 140. In some embodiments, the instructions executable by CPU 104 for implementing the recentness score generator 140 are also stored locally in memory 108. In other embodiments, the communication session data 142, as well as the instructions executable to derive the recentness scores therefrom, are stored and processed at a remote computer such, for example, as a communication server or address book administration and management server.

In some embodiments, the information used for computation of the recentness score for an address entry includes the number of days since that address entry was used successfully to establish a communication session (e.g., phone call) between the display terminal 102 and one of the devices, as devices D₁ to D_{n,} for which an entry is stored for a contact as part of the stored address book contact information 124. Such data is derived from the date of the last communication session. In some embodiments, a threshold may be selected such that only a communication session having a duration of at least X minutes (where X is an integer equal to or greater than one) are counted for purposes of storing the date of the last communication session. A further example of information which can be used in the computation of the recentness score according to some embodiments include the date of the last inbound communication session invite, call completion, or call attempt from the address entry in question. Yet another example includes the “intensity” of SMS usage (i.e., the number of messages that are exchanged within a particular time span) involving one or more address entries associated with a contact, and the recentness of that usage. A still further example includes the date that the user of a display terminal added an address entry to his or her address book.

In some embodiments, inbound communications may be scored, weighed or otherwise calibrated differently than outbound communications. For example, since it is more likely that an address of a contact is still active if an incoming communication is received from that address, that address may be given a higher weight when determining a recentness score for that address.

In some embodiments, a contact's social network accounts/pages/blogs or other types of social network feeds may be accessed/analyzed to determine recent activity to help determine a recentness score of the social network address. For example, the contact information stored in association with a contact may include a social network address for the contact. Thus, the social network address may be given a higher weight/score if the most recent activity determined for contact occurred on a social network account associated with the social network address of the contact.

The operating system (OS) 114 generally manages various computer resources (e.g., network resources, file processors, and/or the like). The operating system 114 is configured to execute operations on one or more hardware and/or software modules, such as Network Interface Cards (NICs), hard disks, virtualization layers, firewalls and/or the like. Examples of the operating system 120 may include, but are not limited to, LINUX, MAC OSX, BSD, UNIX, MICROSOFT WINDOWS, and the like.

FIG. 1B depicts a block diagram of a computer (“server”) 152 for managing and presenting address entries from an address book accessible using display terminal 102 configured as illustrated and described in connection with FIG. 1A, according to one or more other embodiments of the invention. FIG. 1B is similar to FIG. 1A but is directed to a server-implementation of at least some of the address book administration functions. The server 152 comprises Central Processing Unit (CPU) 154, support circuits 156, a memory 158, a display device 160, and transmission and receiving devices 162. In some embodiments server 152 comprise one or more wireless transceivers compliant with corresponding wireless transmission protocol(s) such as IEEE 802.11, IEEE 802.13, BLUETOOTH, and/or cellular transmission protocols such as CDMA, TDMA, and/or GSM.

The CPU 154 may comprise one or more commercially available microprocessors or microcontrollers that facilitate data processing and storage. The various support circuits 156 facilitate the operation of the CPU 154 and include one or more clock circuits, power supplies, cache, input/output circuits, and the like. The memory 158 comprises at least one of Read Only Memory (ROM), Random Access Memory (RAM), disk drive storage, optical storage, removable storage and/or the like. In some embodiments, the display device 150 may be a touch screen able to accept input from a user's finger or input from a stylus. In some embodiments, the memory 158 comprises an operating system 154 and one or more applications 156. In some embodiments, applications 156 include a communication session module 168 configured, by execution of instructions by CPU 154, to set up a telephone call or send an SMS or MMS message to an intended recipient via network 127.

In some embodiments, applications 166 further include a contact administration module 170 comprising contact list configuration settings 172, one or more address books containing contact information 174, and one or more communication address entries 176 for identifying a corresponding communication device to a communication network such as communication network 127. Each address entry includes, for example, a telephone number, an e-mail address, an account identifier, and/or some other network address such as a SIP (Session Initiation Protocol) address. In some embodiments, the address book contact information 174 further includes contact names and classifications 178 including the first and last name of each contact, an entity classification (e.g., business or personal), as well as an recentness score 180 for each address entry. The applications 166 further includes recentness score generator 190 which includes stored communication session data 192 as exemplified in the discussion of FIG. 1A. As will be described shortly, the recentness score generator 140 (FIG. 1A) or 190 (FIG. 1B) utilize the aforementioned communication session data to compute a recentness score that facilitates the display, to the user of display terminal 102, of address entries which are convey information relating to the “freshness” or “staleness” of one address entry for a contact as compared to another address entry for the same contact.

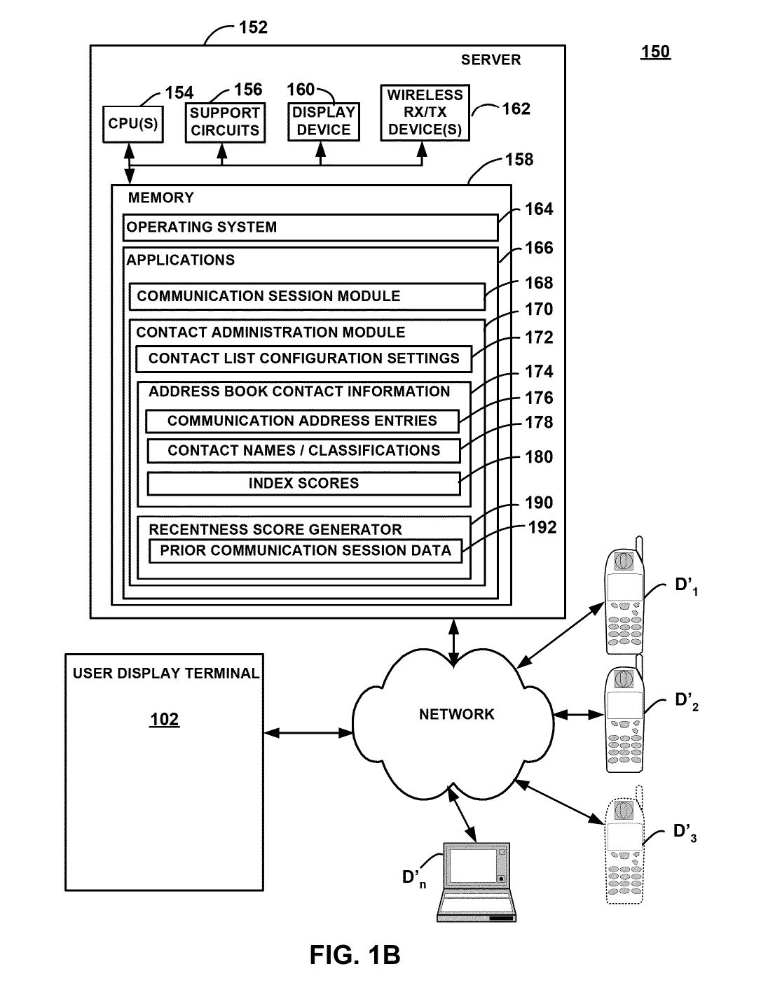

FIG. 2 is a flow diagram of a method for accumulating data useful in assessing the “recentness” of address entries stored as part of contact information in an address book, according to one or more embodiments. The method 200 starts at 202, and generally proceeds to 204.

At 204, the method initiates a communication session between the user of a display terminal and a contact for whom at least one stored address entry accessible from the display terminal exists. In some embodiments, the communication session is a phone call initiated, for example, by sending a request from the user's communication device over a wireless communication channel to establish a wireless or landline call to the contact as an intended recipient. In some embodiments, initiation of a communication session can include both inbound as well as outbound uses of an address entry in the user's address book. Thus, for example, if a contact in the address book initiates the communication session, then the Automatic Number Identification (ANI) accompanying the inbound call set up request, or other type of communication identifier used, is noted and the date of the attempt is stored as part of step 204. The method 200 proceeds to 206.

At 206, the method 200 determines whether or not an outbound communication set up attempt was successful. If so, then the method 200 proceeds to 210. At 210, the time, date, and duration for the outbound communication session are stored in association with the address entry used to establish the communication session. In this context, “in association with” merely refers to the indexing of the communication set up data according to address entry, as in a database, so that it can be retrieved, as needed, to derive an updated recentness score. If the communication session was an exchange of SMS or MMS messages, then the time and date for each SMS or MMS message sent to or received from the contact using the address entry is stored. In some embodiments, intensity data, as represented by an event flag whenever more than X messages are exchanged in a time span of Y minutes, is stored in association with the address entry and a date of the corresponding exchange represented by the event flag, are stored. For example, X may be an integer equal to or greater than 4 and Y may be a number of minutes ranging between 45 and 75 minutes. In some embodiments, only the most recent event flag is stored for purposes of computing a recentness score. In other embodiments, any communication session data, including but not limited to the event flag data and the time and date of phone calls and/or emails using an applicable network address, are retained within a “rolling window” period spanning, for example, one to six months. It will be readily ascertained by the artisan of ordinary skill that the amount of data stored and made available for computation of recentness scores will be dependent upon the complexity of the algorithm and the granularity with which the analysis is to be performed.

If, at 208, a determination is made that the outbound communication attempt was unsuccessful, then in some embodiments, the time and date of the unsuccessful attempt is stored in association with the address entry. From 208 or 210, method 200 proceeds to 212 and terminates.

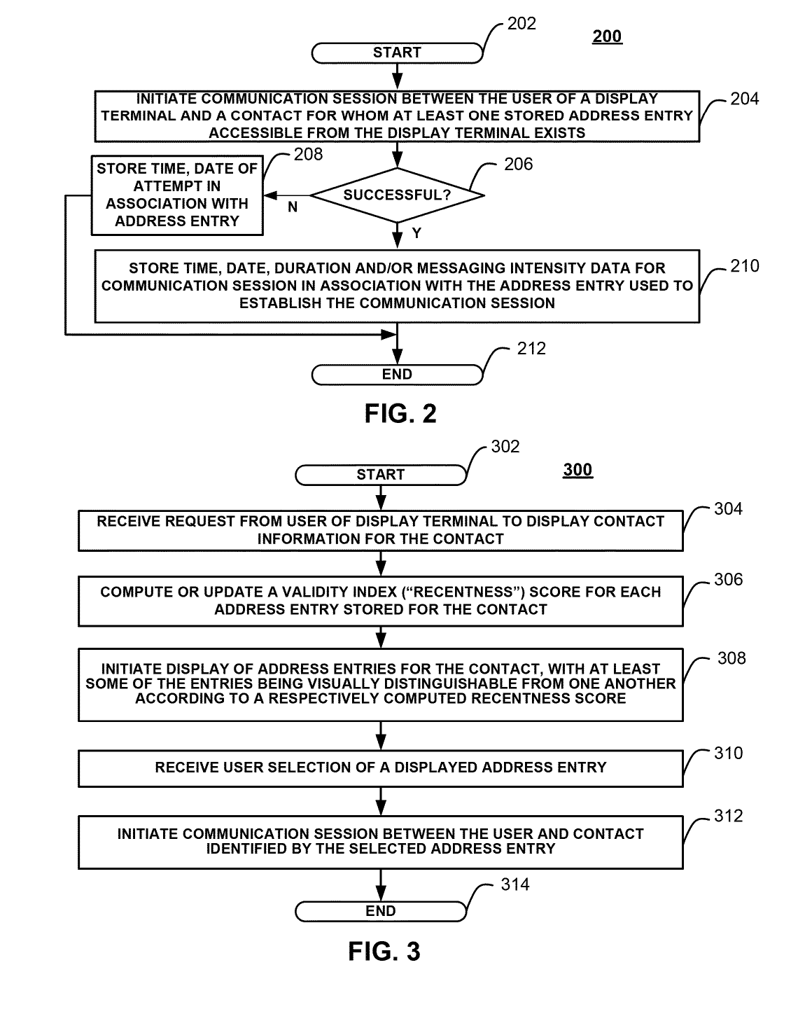

FIG. 3 is a flow diagram of a method 300 for initiating display of address entries according to an assessment of recentness formed according to one or more embodiments of the invention. The method 300 starts at 302 and proceeds to 304. At 304, a request is received to display contact information for the contact. For example, a user may invoke a graphic user interface (GUI) of the display terminal in which a menu is displayed for identification and selection of a particular contact (“intended recipient”) with whom the user wishes to establish a communication session. The contact information rendered to the display as part of the menu may, for example, comprise the name of the intended recipient, a list of phone numbers, SIP addresses, and/or e-mail addresses stored in a local memory of the display terminal and applicable to the intended recipient. In such embodiments, method 300 may be implemented entirely by a mobile terminal such, for example, as a smartphone, personal digital assistant (PDA), tablet, laptop computer, and the like. In other embodiments, some or all of the contact information may be stored at a server, wherein the menu invoked by the GUI constitutes part of a communication client application as, for example, an application configured to initiate and/or accept telephone calls handled by a remote server.

The method 300 proceeds from 304 to 306, where a recentness score is computed (or updated, if a prior score has already been computed) for each address entry stored for the contact identified or selected by the user in the request received at 304. In some embodiments, the recentness score for each of the network addresses (e.g., telephone numbers, SIP addresses, and/or e-mail addresses) of a particular contact is computed or updated every time a request to access that information is accessed by the user of a display terminal. In other embodiments, the recentness score is computed once daily, weekly or at some other regular interval according to a predefined update process. In some embodiments, computation and storage of each recentness score occurs locally, by execution of instructions by a processor of the display terminal. In other embodiments, the computation and storage occurs centrally at a local administrative server. In still other embodiments, the computation is performed centrally at a server but the scores themselves are stored together with the contact information in a memory of the display terminal. The method 300 proceeds to step 308.

At step 308, address entries are displayed for the contact(s) selected and/or identified at 304. At least some of the address entries are visually distinguishable from one another according to their respective recentness scores. The manner in which the address entries are distinguished from one another can vary substantially. For example, in some embodiments, each of the network addresses are rendered to the display in a list of descending or ascending order, according to their recentness (e.g., with the most recent address of each network address type and classification being on the top, or bottom as the case may be, and the oldest being in the position furthest therefrom). In this regard, network address type refers to phone, e-mail, or user name (e.g., “chat” handle) while network address classification refers to a business, personal, academic, or some other group association of use to the user in selecting between the network addresses at different times of day or week. According to some embodiments, the network addresses are consolidated in a single list in order of their recentness, while in still others, the user is presented with a display that allows him or her to select between multiple modes, such that in a first mode, the network addresses are aggregated in the aforementioned consolidated form and, in other modes, the network addresses are organized according to selectable contact type and/or classification.

In some embodiments, address entries are distinguished from one another not (or not solely) on the basis of ascending or descending order but instead using color coding or supplemental distinguishing markings/characters conveying information about their respective recentness. The network address having the highest likelihood of being active based on its date of addition to the contact database, the intensity of usage in the preceding months, and/or the date of the last completed incoming or outgoing communication session will have a higher recentness score that other network addresses for the same contact. As such, a display terminal using that network address to initiate a telephone conversation or SMS/MMS exchange (in the case of a smart phone or other mobile terminal) has a higher probability of call completion or successful message interchange. By extension, the lower the recentness score, the lower the likelihood of such success. In an embodiment, the variations in recentness among multiple network addresses for the same contact are made quickly apparent by rendering the network addresses to a display so that those addresses with a high recentness score are highlighted in one color (e.g., green), those with an intermediate recentness score are highlighted in another color (e.g., yellow), and those below a certain threshold indicative of a sufficient lack of recentness as to induce a display terminal user to choose a higher ranked network address if it is available, is highlighted in yet another color (e.g., red). As an alternative to highlighting, the respective network addresses for a contact can be rendered to the display of the display terminal in a color selected in the basis of recentness score. In accordance with yet another embodiment, a variable number of symbols (e.g., empty or solid circles, or a combination of these) can be used to convey the relative recentness between network addresses having respectively different scores. In some embodiments, the recentness score itself will be displayed proximate to the corresponding address entry. In some embodiments, a last date of use of each address entry is displayed proximate to the corresponding address entry. The method 300 proceeds to 310.

In some embodiments, a user interface rendered to the display of a display terminal, in carrying out 308 of method 300, enables the user to select a network address entry, from among a plurality of such addresses for the same contact, on the basis of its recentness score in comparison to the others. At step 310, a user selection of an address entry of the displayed plurality is received. The method proceeds to 312, where a communication session is initiated (e.g., phone call, SIP call, or a window for authoring and sending an SMS or MMS message). In some embodiments, such as where a network address has several possible uses, the user of a display terminal is presented with a menu for specifying how the selected network address will be used. The method 300 proceeds to 314 and terminates.

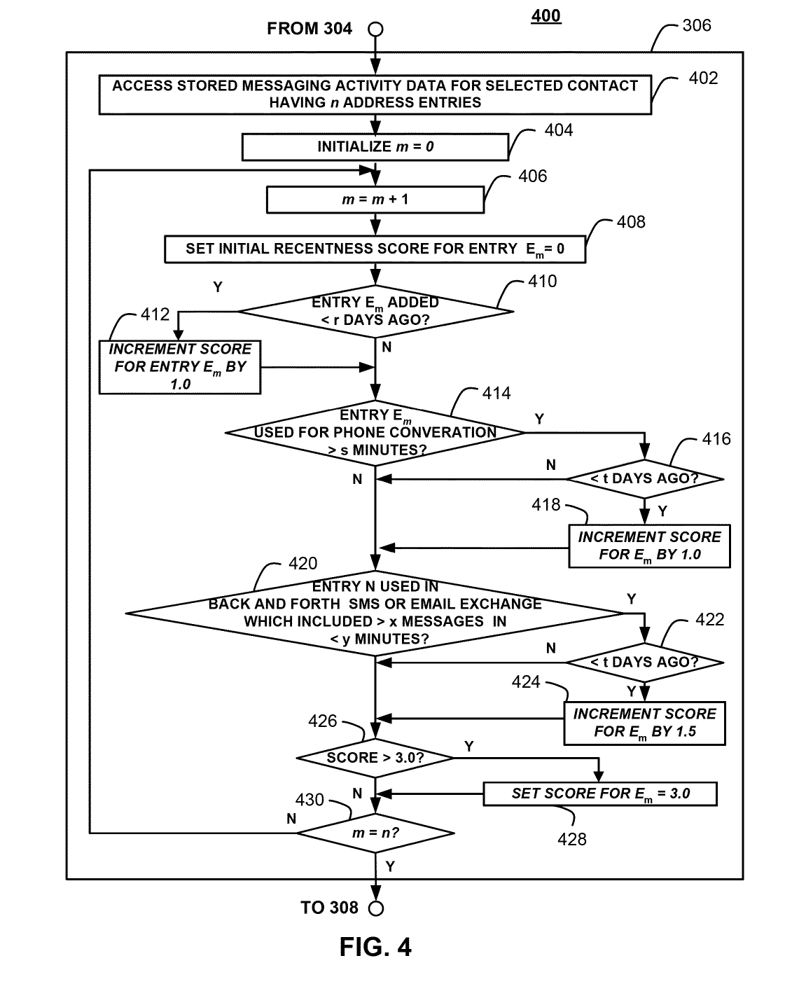

FIG. 4 is a flow diagram of a method 400 for computing a recentness score as, for example, a sub-process of the method of FIG. 3, according to one or more embodiments of the invention. In the illustrative embodiment of FIG. 4, the method 400 is entered from 304 (FIG. 3), after a request is received from the user of a display terminal to display contact information for a particular (selected) contact. As mentioned previously, however, the computation of a recentness score need not depend upon such a selection and may, in fact, simply be a scheduled process which occurs automatically at regular intervals.

In any event, the method 400 proceeds to 402, where the method accesses stored messaging activity data for a selected contact having n address entries, where n is an integer greater than one. The method 400 proceeds to 404, where counter m is initialized to zero. The method 400 proceeds to 406, wherein the counter is incremented by one and, from there, to 408 where an initial score for the first address entry Eₘ is set to zero. The method proceeds from 408 to 410, where a determination is made as to how recently the address entry Eₘ was created. If it is determined that the entry Eₘ was made less than r days ago (where r is an integer), then at 412, the recentness score for address entry Eₘ is incremented by an amount selected to give a higher weight to those address entries which are recently created (as opposed to those which were added to the contact database beyond the r boundary). In an embodiment, the value of r is 100 days though in principle the value may be several times that number or even greater. If at 410 it was determined that the date that address entry Eₘ was added to the contact database exceeds the r boundary, then the recentness score for entry Eₘ is not incremented at all or it is incremented by a smaller amount than as was the case at 412. In the illustrative embodiment of FIG. 4, the recentness score for entry Eₘ is incremented 1.0 for dates of entry less than r days, and by zero if greater than r days. The method proceeds to 414.

At 414, method 400 determines whether the entry Eₘ has been used for greater than s minutes. In the illustrative embodiment, s is an integer greater than one. If so, the method 400 proceeds to 416 where a determination is made as to the recency of that usage. If it was less than t days in the past, then the method advances to 418, the recentness score for entry Eₘ is incremented by 1.0, and then the method proceeds to 420. In the illustrative embodiment, the value of r is 30 days. In some embodiments, the values of r, s and/or t are selectable by a user. In others one or more of these are fixed software parameters obtained, for example, by statistical analysis of a representative sample of subscribers.

If it is determined at 414 that the entry Eₘ has not been used for a conversation lasting more than s minutes, or for such a conversation less than t days ago, then the method 400 proceeds to 420 without incrementing the recentness score for address entry Eₘ. At 420, a determination is made as to the intensity of recent usage of address Eₘ for communication sessions other than voice conversations. In some embodiments, intensity is assessed based on whether entry Eₘ has been used in a back-and-forth SMS or e-mail exchange (as the case may be) which included more than x messages in less than y minutes. In an embodiment, x is an integer greater than or equal to 4 and y is from 45 to 75 minutes. If it is determined at 420 that a threshold level of intensity has been met, then the method 400 proceeds to 422 where a determination is made as to whether a recency threshold for the exchange is a satisfied. If the exchange took place less than t days ago, then the method advances to 424 and the recentness score is incremented by 1.5.

In the illustrative embodiment of FIG. 4, incrementing by a higher amount based on the recent, intense use of an address entry to reach an intended recipient (as compared to the smaller increment amounts at 312 and 418) reflects an expectation that a display terminal identified by that address entry will be more readily accessible to the intended recipient. However, it should be borne in mind that the respective increment amounts, as well as their relative weighting, may be varied without departing from the spirit and scope of the invention. In some embodiments, for example, a statistical analysis of user contact information (e.g., subscribers to a mobile carrier network) may warrant placing a higher weighting, in the recentness scores, on the date an address was added to the network, and in others, on the length and frequency of phone conversations between the user of the display terminal and the intended recipient identified by a particular address entry. For the same reasons, although threshold t is used in both 416 and 422 in the illustrative embodiment depicted in FIG. 4, it should be understood that these thresholds may be different from one another as may be, for example, justified by statistical observation or the like.

From 424, or from 420 or 422, if the usage respective intensity or recency threshold are not met, the method 400 proceeds to 426, where an optional score normalization is performed. In some embodiments, it may be desirable to scale the recentness score such that it does not exceed a set threshold as, for example, the illustrative threshold of 3.0 depicted in FIG. 4. Such normalization makes it possible, for example, to use a smaller number of colors or symbols to delineate the respective address entries by recentness score according to embodiments of the invention.

If the recentness score does exceed 3.0, the method 400 proceeds from 426 to 428 and sets the score for entry Eₘ to 3.0. If not, the method 400 makes no adjustment to the score. In either case, method 400 then advances to 430, where a determination is made as to whether or not a recentness score has been computed for the last address entry stored for the contact. This will be the case when m is equal to n (the total number of address entries accessible at 402). If so, then the method 400 advances to 308 of method 300 (FIG. 3). If not, then the method 300 returns to 406, the increment counter m is advanced by 1, and the recentness score is computed for the next address entry for the applicable contact. The aforementioned process is repeated until there are no more address entries to be processed for the selected contact.

In addition to method 400 for computing a recentness score described with respect to FIG. 4, other methods or algorithms for computing a recentness score may be used. For example, provided an address entry Eₘ was added to an address book r days ago, and given tunable parameters a and B, then Eₘ=a/(r̂B). The tunable parameters a and B may include a combination of values of n, r, s, t, x and/or y discussed above, or other tunable parameters, with respect to FIG. 4. As such, the emphasis of the time passed since the insertion of the entry diminishes as r increases. In addition, similar functions will apply to other meaningful communication events such as calls made and SMS correspondence, thus making them non-discreetly dependent on the amount of time that passed since the communication event.

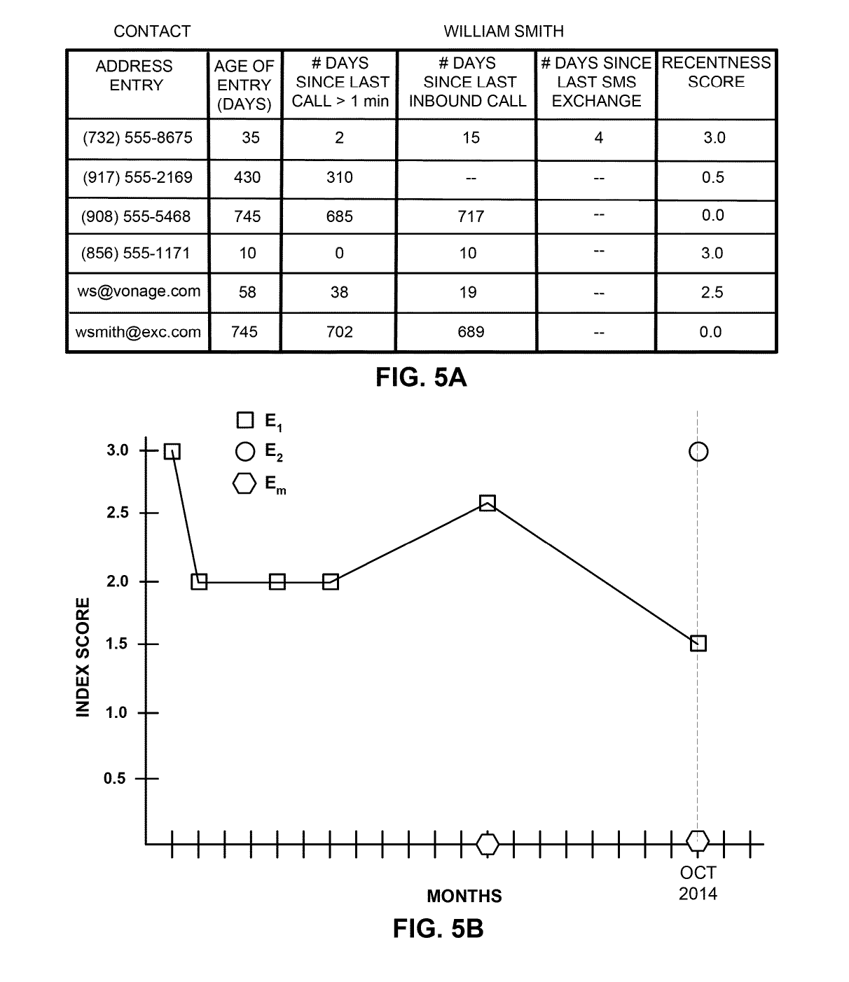

FIG. 5A is a tabular representation of illustrative prior communication session data and address entry creation (or modification) data used to derive recentness scores for a plurality of address entries associated with a contact, according to one or more embodiments. In the exemplary table four phone numbers are identified and two e-mail addresses are listed for the contact “William Smith”. For each of these address entries, a date of addition to the contact database (or date of modification within the contact database) to the accessible by a user of a display terminal is recorded in memory (not shown) and the dates, times and, if applicable, durations of communication session exchanges (e.g., phone conversations, e-mail, SMS or MMS message, or SIP call) are also recorded in a memory (not shown). From this data, the tabulated number of days (or weeks or months) since address creation, address modification, or prior activity, as the case may be, are computed. In the last column, the recentness scores computed, according for example to the illustrative method 400 depicted in FIG. 4, are tabulated for each address entry.

FIG. 5B is a graphical depiction of changes in the recentness of respective address entities with respect to time, as measured according to one or more embodiments. In some embodiments, a graphical depiction of the trend data for various address entries similar to that depicted in FIG. 5B may be optionally displayed to the user. For example, a user may select one or more address entries for which the user wishes to view the trend data.

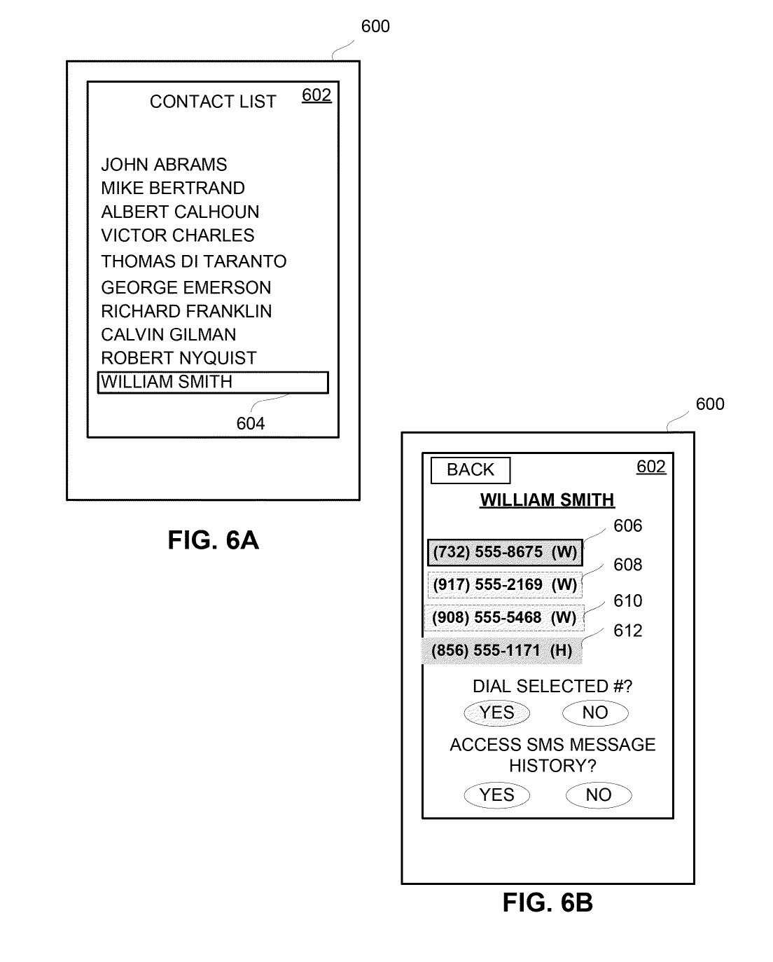

FIG. 6A depicts a display terminal 600 operated by a user to visually present a contact list in an address book on display 602, from which the user of display terminal 600 may specify a contact 604 with whom he or she wishes to initiate a communication session according to one or more embodiments. FIG. 6B depicts the display terminal 600 of FIG. 6A operated by a user to display 602 a list of address entries (607, 608, 610 and 612) for a selected contact, the address entries being visually distinguishable from one another on the basis of recentness according to one or more embodiments. In the illustrative embodiment, the respective address entries are highlighted, with entries 606 and 612 being highlighted in a darker color to reflect a high recentness score to thereby make them distinguishable from entries 608 and 610 highlighted in a lighter color indicative of a low recentness score (e.g., indicative of likely invalid or obsolete status). In some embodiments, the GUI depicted on display 602 offers the user of display terminal 600 the opportunity to dial the selected address entry 606 by clicking or touching the highlighted entry (e.g., entry 606) and then touching or clicking a “yes” soft or feature button rendered to display 602.

An advantage of the embodiments of the invention is that a user need not remove an address entry even when he or she knows it is no longer valid (or unlikely to be so). For example, the user may still wish to have access to old SMS or MMS messages sent to and/or received from an otherwise obsolete mobile telephone number. This, in the exemplary embodiment of FIG. 6B, a user of display terminal 600 may select an address entry having a low recentness score for the purpose of accessing SMS message history associated with that address entry. By scrolling the highlight bar down from address entry 606 down to address entry 608 or 610, for example, a user of the GUI shown in FIG. 6B can readily invoke the displayed menu option for accessing the SMS message history associated with the selected address entry.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a yy list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

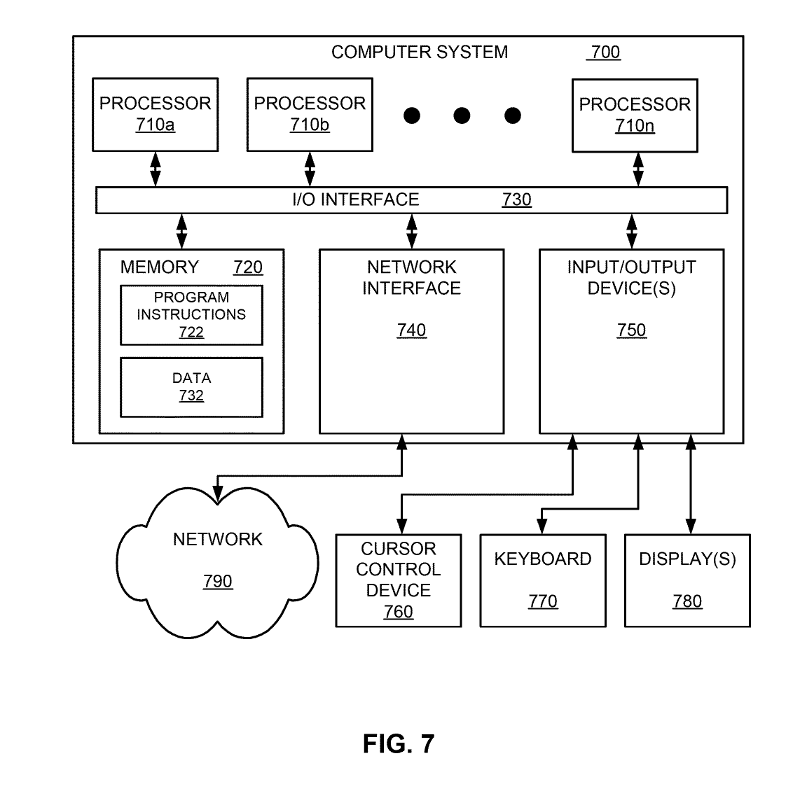

FIG. 7 depicts a computer system 500 that can be utilized in various embodiments of the present invention to implement the computer and/or the display devices, according to one or more embodiments.

Various embodiments of method and apparatus for organizing, displaying and accessing contacts in a contact list, as described herein, may be executed on one or more computer systems, which may interact with various other devices. One such computer system is computer system 700 illustrated by FIG. 7, which may in various embodiments implement any of the elements or functionality illustrated in FIGS. 1-6. In various embodiments, computer system 700 may be configured to implement methods described above. The computer system 700 may be used to implement any other system, device, element, functionality or method of the above-described embodiments. In the illustrated embodiments, computer system 700 may be configured to implement method 200, method 300, and/or method 400 as processor-executable executable program instructions 722 (e.g., program instructions executable by processor(s) 710) in various embodiments.

In the illustrated embodiment, computer system 700 includes one or more processors 710a-710n coupled to a system memory 720 via an input/output (I/O) interface 730. Computer system 700 further includes a network interface 740 coupled to I/O interface 730, and one or more input/output devices 750, such as cursor control device 760, keyboard 770, and display(s) 780. In various embodiments, any of the components may be utilized by the system to receive user input described above. In various embodiments, a user interface may be generated and displayed on display 780. In some cases, it is contemplated that embodiments may be implemented using a single instance of computer system 700, while in other embodiments multiple such systems, or multiple nodes making up computer system 700, may be configured to host different portions or instances of various embodiments. For example, in one embodiment some elements may be implemented via one or more nodes of computer system 700 that are distinct from those nodes implementing other elements. In another example, multiple nodes may implement computer system 700 in a distributed manner.

In different embodiments, computer system 700 may be any of various types of devices, including, but not limited to, a personal computer system, desktop computer, laptop, notebook, or netbook computer, mainframe computer system, handheld computer, workstation, network computer, a set top box, a mobile device such as a smartphone or PDA, a consumer device, video game console, handheld video game device, application server, storage device, a peripheral device such as a switch, modem, router, or in general any type of computing or electronic device.

In various embodiments, computer system 700 may be a uniprocessor system including one processor 710, or a multiprocessor system including several processors 710 (e.g., two, four, eight, or another suitable number). Processors 710 may be any suitable processor capable of executing instructions. For example, in various embodiments processors 710 may be general-purpose or embedded processors implementing any of a variety of instruction set architectures (ISAs). In multiprocessor systems, each of processors 710 may commonly, but not necessarily, implement the same ISA.

System memory 720 may be configured to store program instructions 722 and/or data 732 accessible by processor 710. In various embodiments, system memory 720 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 720. In other embodiments, program instructions and/or data may be received, sent or stored upon different types of computer-accessible media or on similar media separate from system memory 720 or computer system 700.

In one embodiment, I/O interface 730 may be configured to coordinate I/O traffic between processor 710, system memory 720, and any peripheral devices in the device, including network interface 740 or other peripheral interfaces, such as input/output devices 750. In some embodiments, I/O interface 730 may perform any necessary protocol, timing or other data transformations to convert data signals from one component (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components, such as a north bridge and a south bridge, for example. Also, in some embodiments some or all of the functionality of I/O interface 730, such as an interface to system memory 720, may be incorporated directly into processor 710.

Network interface 740 may be configured to allow data to be exchanged between computer system 700 and other devices attached to a network (e.g., network 790), such as one or more display devices (not shown), or one or more external systems or between nodes of computer system 700. In various embodiments, network 790 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 740 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 750 may, in some embodiments, include one or more display terminals, keyboards, keypads, touchpads, scanning devices, voice or optical recognition devices, or any other devices suitable for entering or accessing data by one or more computer systems 700. Multiple input/output devices 750 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 740.

In some embodiments, the illustrated computer system may implement any of the methods described above, such as the methods illustrated by the flowcharts of FIGS. 2-4. In other embodiments, different elements and data may be included.

Those skilled in the art will appreciate that computer system 700 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A computer-implemented method, comprising:
receiving a request to display contact information associated with a contact stored in an address book associated with a first user, wherein the stored contact information includes a plurality of address entries; and
displaying at least some of the plurality of address entries for the contact, wherein at least one displayed address entry is visually distinguishable from at least one other displayed entry for the contact based on a recentness score associated with each of the plurality of address entries.

2. The method of claim 1, where the recentness score is calculated for each address entry associated with the contact based on at least one of stored prior communication session data, a date of address entry creation, or a date of address modification.

3. The method of claim 2, wherein an order of the plurality of address entries for the contact displayed is based on the recentness score for each address entry.

4. The method of claim 2, wherein displaying the at least some of the plurality of address entries for the contact includes comparing the recentness score to at least one predefined threshold.

5. The method of claim 4, wherein address entries having a recentness score below the at least one predefined threshold are displayed in a different color than address entries having a recentness score above the at least one predefined threshold.

6. The method of claim 2, wherein the recentness score for each address entry is displayed proximate to a corresponding address entry.

7. The method of claim 2, wherein a last date of use of each address entry is displayed proximate to a corresponding address entry.

8. The method of claim 2, further comprising:
storing, as prior communication session data, a date and duration of a communication session established between a first user device associated with the first user and a second user device associated with a first address entry associated with the contact; and
updating the recentness score of the first address entry based on the prior communication session data.

9. The method of claim 2, further comprising:
storing, as prior communication session data, a date and time for each text message sent or received between a first user device associated with the first user and a second user device associated with a first address entry associated with the contact; and
updating the recentness score of the first address entry based on the prior communication session data.

10. The method of claim 1, wherein each address entry includes one of a telephone number, an e-mail address, an account identifier, or a Session Initiation Protocol (SIP) address.

11. The method of claim 1, further including:
storing a new address entry associated with the contact in the address book; and
storing a date of adding the new address entry in association with the new address entry.

12. The method of claim 1, wherein displaying the at least some of the plurality of address entries for the contact includes rendering each address entry to be displayed with one of color coding or highlighting based on the address entry's recentness score.

13. A computer-implemented method, comprising:
calculating a recentness score for each address entry of a plurality of entries associated with a contact stored in an address book associated with a first user based on at least one of stored prior communication session data, a date of address entry creation, or a date of address entry modification; and
storing the calculated recentness score for each address entry in association with a corresponding address entry.

14. The method of claim 13, wherein each address entry includes one of a telephone number, an e-mail address, an account identifier, or a Session Initiation Protocol (SIP) address.

15. The method of claim 13, further comprising:
causing each address entry to be rendered by a display terminal with one of color coding or highlighting based on the address entry's recentness score.

16. A system for presenting contact information in an address book on a display terminal, comprising:
an address book associated with a first user, wherein the address book includes at least one contact including a plurality of address entries;
prior communication session data database storing prior communication session data associated with each address entry of the plurality of address entries for the at least one contact;
a recentness scoring generator configured to calculate a recentness score for each address entry of the plurality of address entries for the at least one contact; and
a display terminal configured to display at least some of the plurality of address entries for the contact, wherein at least one displayed address entry is visually distinguishable from at least one other displayed entry for the contact based on the recentness score associated with each of the plurality of address entries.

17. The system of claim 16, where the recentness scoring generator is configured to calculate the recentness score for each address entry associated with the contact based on at least one of stored prior communication session data, a date of address entry creation, or a date of address entry modification.

18. The system of claim 17, wherein an order of the plurality of address entries for the contact displayed is based on the recentness score for each address entry.

19. The system of claim 17, wherein the display terminal is configured to display the recentness score for each address entry proximate to a corresponding address entry.

20. The system of claim 16, wherein the each address entry includes one of a telephone number, an e-mail address, an account identifier, or a Session Initiation Protocol (SIP) address.
